(19) United States
(12) Patent Application Publication
(10) Pub. No.: US 2006/0140852 A1
(43) Pub. Date: Jun. 29, 2006

(54) Hydrogen generator having sulfur compound removal and processes for the same

(76) Inventors: Bradley P. Russell, Wheaton, IL (US); Kishore J. Doshi, Fernandina Beach, FL (US); Jayant K. Gorawara, Buffalo Grove, IL (US)

Correspondence Address: Nick C Kottis;Pauley Petersen & Erickson, Suite 365, 2800 West Higgins Road, Hoffman Estates, IL, 60195, US

(21) Appl. No.: 10/529,839

(22) PCT Filed: Oct. 8, 2003
(86) PCT No.: PCT/US03/31858

§ 371 Date: Sep. 2, 2005

Related U.S. Application Data
(60) Provisional application No. 60/417,423, filed on Oct. 9, 2002.
(60) Provisional application No. 60/472,804, filed on May 22, 2003.

(51) Int. Cl. C01B 3/26

(52) U.S. Cl. 423/652

(57) ABSTRACT

Apparatus and processes for the generation of hydrogen from hydrocarbon feeds are provided in which organosulfur compound is removed from the feed. The apparatus and processes are particularly advantageous as smaller scale hydrogen generators including those generators intended for residential use to produce hydrogen for fuel cells to produce electricity. In the processes and apparatus, the feed is contacted with solid sorbent to remove organosulfur compound.

### FIELD OF THE INVENTION

This invention relates to apparatus and continuous processes for generating hydrogen with removal of sulfur compounds from hydrocarbon feeds, especially to smaller scaled hydrogen generators and processes for on-site generation of hydrogen for fuel cells. In the processes and apparatus of this invention the sulfur compounds are continuously removed with one aspect involving the use of a regenerative sorption process and with another aspect involving the removal of sulfur compounds, including carbonyl sulfide and carbon disulfide using a hydrolysis in combination with sorption. The processes and apparatus can be economically and environmentally attractive.

### BACKGROUND OF THE INVENTION

Fuel cells convert the chemical energy of a fuel, hydrogen, into usable electricity via a chemical reaction without employing combustion as an intermediate step. Hydrogen is difficult to store and distribute and has a low volumetric energy density compared to fuels such as gasoline. Advantageously, the hydrogen feed for fuel cells will be produced at a point near the fuel cell.

The production of hydrogen from fuels such as natural gas, propane, butane, and the like is known. These fuels are more easily stored and distributed than hydrogen. Thus, the use of these types of fuels for hydrogen generators to supply hydrogen at a point near the fuel cell would be advantageous.

Hydrogen is produced for chemical and industrial processes in large-scale processes based on steam reforming of hydrocarbons. These processes, due to their large scale and often integration with refinery or chemical process operations, can rely upon sophisticated unit operations to economically produce hydrogen. Much greater challenges exist in producing hydrogen in smaller scale units as will be needed to supply hydrogen at a point near a fuel cell. The severity of this challenge is increased where the fuel cell is for residential or small business use. Not only will the hydrogen generator need to operate without sophisticated technical expertise provided by plant operators, but the generator and its operation must be sufficiently economical to be competitive with alternative sources of hydrogen or electricity. Moreover, especially for residential use, the hydrogen generator should be compact and require minimal maintenance.

The complexities in providing a simple, inexpensive, and efficient hydrogen generator are multifold and include difficulties either not faced by, or much more easily surmounted by, large-scale industrial hydrogen generation units. One of those complexities for hydrogen generators using hydrocarbon feeds such as natural gas or liquified petroleum gas is that sulfur compounds are present, including those sulfur compounds added as odorants for leak detection. If not removed, the sulfur compounds can poison catalysts used to convert the feed to hydrogen. Hence, the developer of a smaller scale hydrogen generator must integrate into the unit a means to remove sulfur without unduly adversely affecting the performance or economics of the hydrogen generator. Further, the sulfur removal should advantageously be accomplished in an environmentally acceptable manner.

A conventional approach for desulfurization in industrial scale processes is a two-stage hydrodesulfurization process. The process requires high temperatures, usually on the order of 350° C., as well as a hydrogen recycle stream. This type of process is too complex and expensive for a small scale hydrogen generator. Further, the use of a hydrogen recycle can require an additional gas compressor and can reduce the efficiency of the hydrogen generator.

Various proposals for alternative means for removal of sulfur compounds from hydrocarbon feeds have included adsorption on zinc oxide or molecular sieves. With zinc oxide or most similar chemisorbents, elevated temperatures (e.g. greater than 200° C.) are required for removal of some types of sulfur compounds, such as dimethyl sulfide and tetrahydrothiophene. On the other hand, molecular sieves (i.e. zeolites) are generally effective for removal of most sulfur compounds at room temperature. Adsorption of sulfur compounds on molecular sieves can be adversely affected by the presence of polar components such as water and carbon dioxide in the hydrocarbon feedstock. For example, the presence of moisture and carbon dioxide in pipeline natural gas can greatly diminish sulfur loadings on molecular sieves. Coadsorption of hydrocarbons from the feedstock can also diminish sulfur loadings on molecular sieves. A limitation of both zinc oxide adsorbents and molecular sieves is that they are not effective for removal of carbonyl sulfide and carbon disulfide.

Bruno, et al., U.S. Pat. No. 6,334,949, propose the use of calixarene complexing agent because of problems associated with other proposed methods for carbonyl sulfide removal such as amine treatment, hydrolysis, reaction with zinc oxide, adsorption on promoted activated alumina or molecular sieves and reaction with alkali metal hydroxide or methanol. Satokawa, et al., in U.S. Published Application 2001/14304 disclose the use of transition-metal exchanged zeolites for removing sulfur components from moist streams. However, Satokawa, et al., provide no disclosure pertaining to regeneration of the zeolites in the operation of the hydrogen generator. The benefits asserted by the patentees is that the zeolite is relatively hydrophobic and thus will be operative for removing sulfur compounds from moisture-containing feeds.

Additional challenges exist. For instance, the means for removal of sulfur compounds should be easily integrated into the hydrogen generator and not require undue energy to operate or excessive pieces of equipment. Ideally, the desulfurization would occur at or near ambient temperatures.

### SUMMARY OF THE INVENTION

The apparatus and processes of this invention provide for effective sulfur removal from feeds to hydrogen generators. The hydrogen generator and the hydrogen generator/fuel cell systems using the apparatus and processes of this invention can be relatively compact and can be relatively maintenance-free as desired for residential and other small-scale applications.

The processes and apparatus of this invention use a solid sorbent capable of removing organosulfur compound, and use a hydrolysis step to convert CXS, where X is oxygen or sulfur, i.e., carbonyl sulfide and carbon disulfide, to hydrogen sulfide for sorption on the solid sorbent and a regeneration of the solid sorbent using process streams in the hydrogen generator. The feed to the hydrogen generator is contacted with the solid sorbent under sorption conditions including a temperature of less than about 50° C. for a time sufficient to sorb at least about 70 mole percent of the total sulfur compounds contained in the stream having a reduced CXS content.

Removal of CXS

In one aspect of the apparatus and processes of this invention CXS is removed first from a hydrocarbon-containing gas stream containing one or both of carbonyl sulfide and carbon disulfide and containing organosulfur compound and possibly hydrogen sulfide. The organosulfur compounds and hydrogen sulfide are removed subsequently. The apparatus has a first reactor having a gas stream inlet and a spaced apart gas stream outlet. The first reactor contains a bed of catalyst positioned such that a gas stream passing from said inlet to said outlet passes through said bed. The catalyst comprises a hydrolysis catalyst capable of promoting the reaction of the CXS sought to be removed with water vapor at a temperature of less than about 100° C. A second vessel has a gas stream inlet in fluid communication with the gas stream outlet of the first reactor and a gas stream outlet. It contains a bed of solid sorbent positioned such that a gas stream passing from said inlet to said outlet passes through said bed. The solid sorbent is capable of sorbing dimethyl sulfide at a temperature of 50° C. from a methane stream containing 50 ppmv water.

Alternatively, the feed stream is first treated to remove the organosulfur compounds and hydrogen sulfide, if present. The CXS which is not removed in the first adsorption step, is subjected to hydrolysis in a subsequent step. Usually water is added as any water contained in the feed stream is generally sorbed during the organosulfur-removal step. The resultant hydrogen sulfide-containing stream from the hydrolysis unit is subjected to a further sorption step. The subsequent sorption step may be a high temperature sorption. While a low temperature sorption can be used, it is less preferred if heat exchange is needed.

The apparatus and processes require little energy consumption for their operation. Any heating required from ambient temperature for the hydrolysis or for a high temperature hydrogen sulfide sorption can be effected by waste heat from the hydrogen generator or, if present, fuel cell. In fact, separate heat exchange equipment is often unnecessary even if higher temperatures are desired, as physical location of desulfurization beds near hot vessels in the hydrogen generator can be adequate to achieve elevated temperatures.

When the hydrolysis precedes the organosulfur sorption, sufficient water may inherently be present in the hydrocarbon-containing feed and no water addition need be effected.

Advantageously, the apparatus can be relatively compact. Because the organosulfur sorption can be conducted at substantially ambient temperatures, maintenance and replacement are facilitated. Even when the hydrolysis is subsequent to the sorption of the organosulfur compounds, and a zinc oxide or iron oxide bed is used to remove hydrogen sulfide, the volume of sorbent can be relatively small.

Regeneration of Solid Sorbent

In this aspect of the processes and apparatus of this invention, organosulfur compound is removed from a hydrocarbon feed to a hydrogen generator using a solid sorbent, and the solid sorbent is regenerated using process streams used in the hydrogen generator. The regeneration can be accomplished efficiently and in an environmentally-acceptable manner.

In the broad aspects, the solid sorbent alternates between a sorption and desorption mode. In the sorption mode, the sorbent is contacted with the hydrocarbon feed for the hydrogen generator, which feed also contains at least one organosulfur compound. In the desorption mode, it is contacted with a process stream used in the combustion of a combustion fuel to provide heat within the hydrogen generator. Thus, with the in situ regeneration of the solid sorbent, the process can operate continuously, i.e., without a purposeful shut down to replace spent sorbent. Since the sorbent can be regenerated, a lesser volume is required than that required if the sorbent were to be replaced when spent.

The process stream used for the desorption may conveniently be one or both of an oxygen-containing stream or a combustion fuel stream having an essential absence of sulfur compounds such as an anode waste gas from a fuel cell. The oxygen-containing stream for the regeneration may be one or more of the oxygen-containing gas fed to the hydrogen generator for chemical reaction or combustion purposes or cathode waste gas if the hydrogen generator is integrated with a fuel cell.

If desired, the desorption effluent, or purge, which contains desorbed sulfur compounds, can be combusted to provide heat within the hydrogen generator. The combustion will also oxidize the sulfur compounds to odorless sulfur dioxide. By the present invention, other components removed during desorption and thus contained in the purge will also be combusted. For instance, the solid sorbent will contain residual hydrocarbon feed in the interstitial spaces and, in many instances, sorbed on the solid sorbent. The combustion of such hydrocarbon feed will yield carbon dioxide and water. With many hydrocarbon feeds, such as natural gas and liquefied petroleum gas (LPG), compounds that can pose environmental concerns such as benzene may be present and may be sorbed. Advantageously, the processes of this invention advantageously remove these components from the solid sorbent during desorption for combustion.

Not only can the volume of solid sorbent be reduced through regeneration by desorption, but also, a broader range of solid sorbent materials can be used and greater process flexibility can be provided than if solid sorbent were used in a non-cyclic manner. For instance, moisture-containing streams can be used even though water will compete for sites that would sorb the sulfur compound. Advantageously in accordance with the present invention, the frequent cycling permits the use of water-containing feed and regenerating gas streams. In a non-regenerated system, water competes with sulfur compound for sorption sites and thus reduces the capacity of the sorbent available to the sulfur compounds. However, the presence of water, provided that the sorbent is not physically affected, can be tolerated since the sorbent can be cycled frequently, and unduly large beds to accommodate the presence of water are not required. Water may even be beneficial where the desorption is effected by water displacement of the sulfur compound from the sorbent during regeneration (displacement purge).

A further benefit of the invention is that a sufficient quantity of purge gas for desorption is available from process streams within the hydrogen generator/system to effect desired regeneration. The range of sorbents and desorption streams can permit regeneration without the need to resort to energy-consuming pressure or temperature swings. Nevertheless, the broad aspects of the invention contemplate the use of pressure and temperature swings albeit in many instances they are less preferred modes of operation as compared to isobaric, isothermal inert purge or displacement purge desorptions. Further, the regenerative solid sorbent system of this invention can be used with other operations for sulfur removal.

In the aspects of this invention pertaining to continuous processes for generating hydrogen from a hydrocarbon feed containing one or more organosulfur compounds by reforming the hydrocarbon feed to provide a reformate containing hydrogen, carbon dioxide and carbon monoxide and reducing the concentration of carbon monoxide in the reformate, wherein:
a) at least a portion of the feed is contacted with a bed of solid sorbent capable of reversibly sorbing at least one of said organosulfur compounds under sorption conditions for a time sufficient to sorb at least a portion of said at least one organosulfur compound to provide a hydrocarbon sorption effluent, said bed being one of two or more beds adapted to cycle between sorption and desorption modes,
b) the sorption effluent is reformed in the presence of steam under reforming conditions to provide a hydrogen-containing stream,
c) in the desorption mode at least a portion of a combustion fuel, provided that the fuel has an essential absence of sulfur compound, or oxygen-containing gas for said combustion is passed to at least one other bed containing said solid sorbent under desorption conditions to regenerate the bed and provide an organosulfur-containing purge,
d) the organosulfur-containing purge is used in a combustion to provide heat for use within the processes and to convert organosulfur compound to sulfur dioxide, and
e) the bed of step (a) is cycled to step (c) and the bed of step (c) is cycled to step (a).

The heat provided by the combustion of step (c) can be used to heat any suitable process stream including feed streams to the process, water for conversion to steam for use in the process, the sorption effluent or the reformer, and the like. Often the combustion provides heat to the sorption effluent, either in a preheating step or during reforming. As is readily apparent, the organosulfur-containing purge may comprise combustion fuel or an oxygen-containing gas or a mixture. If not a mixture, the needed component for the combustion is provided.

The hydrogen generators of this invention comprise:
a) a reformer in fluid communication with a supply of water for steam;
b) a combustor in fluid communication with a supply of oxygen-containing gas and with a supply of combustion fuel, said combustor adapted to combust the combustion fuel with the oxygen-containing gas to provide an effluent and provide heat within the hydrogen generator, and
c) at least two zones containing solid sorbent wherein one zone has an inlet in fluid communication with a supply of hydrocarbon feed and an outlet in fluid communication with the reformer to provide hydrocarbon for reforming such that the hydrocarbon feed passes through said one zone to contact solid sorbent, and wherein another zone has an inlet in fluid communication with a supply of regeneration gas comprising at least one of oxygen-containing gas and combustion fuel and an outlet in fluid communication with the combustor such that regeneration gas passes through said another zone to contact solid sorbent, said outlet being in fluid communication with the combustor to provide at least one of oxygen-containing gas and combustion fuel, said zones being in a relationship to enable solid sorbent to cycle between contacting the hydrocarbon feed and the regeneration gas.

When integrated with a fuel cell, cathode or anode waste gas may be used for the regeneration.

### BRIEF DESCRIPTION OF THE DRAWINGS

FIG. 1 is a schematic representation of an apparatus of the invention in which a hydrocarbon-containing feed is first subjected to hydrolysis to convert CXS, e.g., carbonyl sulfide, to hydrogen sulfide and then is contacted with a sorbent for organosulfur compounds and hydrogen sulfide.

FIG. 2 is a schematic representation of an apparatus of the invention in which a hydrocarbon-containing feed is first subjected to sorption to remove organosulfur compounds and then the feed is contacted in the presence of water vapor with a hydrolysis catalyst. The feed is thereafter contacted with a sorbent for hydrogen sulfide.

FIG. 3 is a schematic representation of an apparatus of the invention in which a hydrocarbon feed is used for steam reforming and organosulfur compound is removed using solid sorbent and air is used to regenerate the sorbent and the desorption stream is used in a combustion to provide heat to the steam reformer.

FIG. 4 is a schematic representation of an apparatus of the invention in which a hydrocarbon feed is first subjected to hydrolysis to convert CXS, e.g., carbonyl sulfide, to hydrogen sulfide and then is contacted with a sorbent for organosulfur compounds and hydrogen sulfide.

FIG. 5 is a schematic representation of an apparatus of the invention wherein hydrogen is produced for use in a fuel cell. Anode waste gas from the fuel cell is used to regenerate the sorbent which is in a moving bed, and the desorption stream is combusted in a preheater.

FIG. 6 is a schematic representation of an apparatus in accordance with the aspect of the invention wherein the purge from regenerating the sorbent is subjected to further sulfur removal.

### DETAILED DESCRIPTION OF THE INVENTION

In the processes of this invention a hydrocarbon feed which also contains organosulfur compound is to be used for reforming to produce hydrogen. Reforming is typically a catalytic reaction conducted at elevated temperatures and may be steam reforming, partial oxidation and steam reforming, autothermal reforming, and the like. Reforming provides a reformate containing not only hydrogen but also carbon dioxide and carbon monoxide.

The generation of hydrogen, for instance, for feed to a fuel cell will also involve the conversion of carbon monoxide produced in the reforming reaction. The conversion may be a water gas shift reaction whereby water and carbon monoxide are reacted to produce additional hydrogen and carbon dioxide. Another carbon monoxide conversion process is a preferential oxidation reaction through which selectively carbon monoxide is oxidized in the presence of free oxygen to carbon dioxide. As is known in the art, the hydrogen generation process may include various operations for preparing the hydrogen product for use in a fuel cell such as dew point control. Also, in some instances, it may be desired to remove carbon dioxide or other inerts in the hydrogen stream.

A fuel cell uses the hydrogen and oxygen-containing gas to generate electricity. The fuel cell also produces an anode waste gas depleted in hydrogen and a cathode waste gas depleted in oxygen. These streams may still contain sufficient heat and hydrogen and oxygen to be of value in an integrated hydrogen generator/fuel cell system.

The hydrocarbon feeds used in accordance with the invention are typically gaseous under the conditions of the desulfurization. Lower hydrocarbon gases such as methane, ethane, propane, butane and the like may be used. Because of availability, natural gas and liquid petroleum gas (LPG) are most often used as feeds.

Natural gas and liquid petroleum gas typically contain odorants such that leaks can be detected. Odorants conventionally used are one or more organosulfur compounds such as organosulfides, e.g., dimethyl sulfide, diethyl sulfide, and methyl ethyl sulfide; mercaptans, e.g., methyl mercaptan, ethyl mercaptan, and t-butyl mercaptan; thiophenes of which tetrahydrothiophene is the most common; and the like. The amount used can vary widely. For natural gas, the organosulfur component is often in the range of about 1 to 20 parts per million by volume (ppmv); and for LPG a greater amount of sulfur compounds are typically used, e.g., from about 10 to 200 ppmv. It is not unusual for commercially obtained hydrocarbon feeds to contain also other sulfur compounds which may be natural impurities such as hydrogen sulfide, And CXS. Carbonyl sulfide concentrations in natural gas and LPG of 0.1 to 5 ppmv are not unusual. Regardless of the form of the sulfur, it can be deleterious to catalysts used in hydrogen generators and to fuel cells.

The feeds can contain other impurities such as carbon dioxide, nitrogen and water. In the processes of this invention, it is preferred that the concentration of carbon dioxide be less than about 5, preferably less than about 2, volume percent.

Water in addition to that contained in the other feed components to the process may be required. This additional water preferably is deionized. The source of the oxygen-containing raw material may be pure oxygen, oxygen-enriched air, or most conveniently, air. When enriched, the air frequently contains at least about 25, often at least about 30, volume percent oxygen.

Hydrogen generating processes are known and may use a variety of unit operations and types of unit operations. For instance, the feed components to the reformer are typically admixed prior to being passed to the reformer. The feed, or components of the feed, can be heated prior to entry into the hydrogen generator or within the hydrogen generator. In some instances it may be desired to heat the fuel prior to admixing with steam and oxygen, especially if the fuel is a liquid under normal conditions to vaporize it.

The reforming may be via steam reforming alone or may be effected by a combination of partial oxidation of the fuel being passed to the reformer and steam reforming. Steam reforming is a catalytic reaction producing hydrogen and carbon oxides (carbon dioxide and carbon monoxide) conducted under steam reforming conditions. Steam reforming conditions usually comprise temperatures in excess of 600° C., e.g., 600° C. to 1000° C., and pressures of from about 1 to 25 bar absolute.

Partial oxidation reforming conditions typically comprise a temperature of from about 600° C. to about 1000° C., preferably about 600° C. to 800° C. and a pressure of from about 1 to about 25 bar absolute. The partial oxidation reforming is catalytic. The overall partial oxidation and steam reforming reactions for methane are expressed by the formulae:
CH₄+0.5O₂→CO+2H₂
CH₄+H₂O [symbol] CO+3H₂

The reformer may comprise two discrete sections, e.g., a first contact layer of oxidation catalyst followed by a second layer of steam reforming catalyst, or may be bifunctional, i.e., oxidation catalyst and steam reforming catalyst are intermixed in a single catalyst bed or are placed on a common support. The partial oxidation reformate comprises hydrogen, nitrogen (if air is used as the source of oxygen), carbon oxides (carbon monoxide and carbon dioxide), steam and some unconverted hydrocarbons.

The reformate, reforming effluent, is a gas and is passed to the shift reactor which contains at least one water gas shift reaction zone. The reformate is typically at temperatures in excess of about 600° C. as it exits the reformer. The reformate is cooled prior to being passed to the shift reactor to water gas shift conditions. In the shift reactor carbon monoxide is exothermically reacted in the presence of a shift catalyst in the presence of an excess amount of water to produce additional amounts of carbon dioxide and hydrogen. The shift reaction is an equilibrium reaction. The reformate thus has a reduced carbon monoxide content.

Although any number of water gas shift reaction zones may be employed to reduce the carbon monoxide level in the hydrogen product, two water shift catalyst stages are often used. The first shift catalyst stage is for a high temperature shift at high temperature shift conditions comprising temperatures between about 320° C. and about 450° C. The effluent from the high temperature shift stage is fed to a low temperature shift stage operating at low temperature shift conditions. The effluent from the high temperature shift stage is cooled to temperatures suitable for the low temperature shift. The low temperature shift conditions usually comprise a temperature between about 180° C. and about 300° C.

The water gas shift effluent stream or hydrogen product typically comprises less than about 1, preferably less than about 0.5, mol % carbon monoxide (on a dry basis). The effluent may be further treated in a suitable manner to remove further carbon monoxide (such as by selective oxidation of carbon monoxide to carbon dioxide) and excess water (as the amount of water required for the cooling of the reforming unit effluent exceeds that required for the shift reaction and for providing a wet gas).

If it is required to reduce the CO concentration to very low levels, such as less than 50 ppm mol, or less than 10 ppm mol, a preferential oxidation step may follow the water gas shift step. In the preferential oxidation step, the hydrogen-containing stream is contacted at effective conditions with a selective oxidation catalyst in the presence of an oxygen-containing stream to selectively oxidize carbon monoxide to carbon dioxide and produce a product stream comprising between about 10 and 50 ppm-mol carbon monoxide. The thus purified fuel stream is passed to an anode side of the fuel cell and an air stream is passed to the cathode side of the fuel cell. Alternatively, the hydrogen-containing stream may be further treated, e.g., by absorption, membrane separation or thermal or pressure swing adsorption, to increase hydrogen product purity. The treatment may, for instance, remove carbon dioxide, additional amounts of carbon monoxide, or other diluents in the hydrogen product stream.

The apparatus and process of this invention use solid sorbent for removal of oragnosulfur compound. Other sulfur compounds may also be removed in accordance with the processes of the invention such as hydrogen sulfide. Some sorbents, such as molecular sieves, may have little capacity for sorbing CXS. When CXS is present, it may be desired to use a hydrolysis to convert CXS to hydrogen sulfide and carbon dioxide or to use another sorption selective for CXS.

If a hydrolysis is used, water is preferably provided in hydrocarbon-containing gas from about 5 to 100 moles of water per mole of CXS. The water-containing stream is contacted under hydrolysis conditions including a temperature of about 25° to 100° C. with hydrolysis catalyst for a time sufficient to hydrolyze at least about 70 percent of the carbonyl sulfide to hydrogen sulfide and carbon dioxide, according to the following reaction:
COS+H₂O=CO₂+H₂S
and produce a hydrocarbon-containing stream having reduced carbonyl sulfide content. Water can also hydrolyze carbon disulfide.

The sorption is reversible, that is, the solid sorbent is capable of being regenerated using a process stream. The mechanism of sorption may vary and is not critical to the invention. As stated above, the regeneration may occur by an inert purge or may proceed through a water displacement mechanism. In the water displacement mechanism, water may be contained in the desorption gas in amounts up to saturation, generally, from about 1 mol % to 15 mol %, depending primarily on the temperature of the water-containing desorption stream. In the preferred aspects of the invention, the sorption and desorption are conducted at low temperatures, for instance, from about 0° to 60° C., most preferably from about 10° to 50° C., and sometimes from 0° to 35° C. The sorption pressure is generally determined by the operating pressure of the hydrogen generator. For fuel cell applications the sorption pressure is usually about 115 to 200 kPa absolute. For industrial gas or hydrogen refueling applications, the sorption pressure may be about 600 to 1,200 kPa absolute. The desorption step in the cycle is preferably conducted at low pressures—generally about 105 to 140 kPa absolute. Thus, the sorption/desorption cycle may include a significant pressure swing.

The volume of sorbent and the duration of the sorption and desorption modes will depend upon the temperature and pressure conditions during the sorption and desorption modes, the volumetric purge to feed ratio, the components of the feed and the desorption gas including the amounts and nature of the sulfur compounds in the feed, the sorbent used, and the like. The determinations of sorbent volume and duration of the sorption and desorption modes will also depend upon any size constraints imposed by the application of the hydrogen generator. With more frequent cycling, smaller volumes of adsorbent are required. For residential and small product production uses, the cycles are sufficiently frequent that the size of the bed of sorbent is compatible with the objective of having a compact hydrogen generator. The duration of the cycles is sometimes less than about 100 hours, and may be less than 24 hours, even less than 30 minutes. Usually, the gas hourly space velocity based on the hydrocarbon feed is between about 10 and 2,000, say, 10 to 1,000, hour⁻¹.

The sorbent may be in a fixed bed or in a moving bed, i.e., the sorbent may be transported between sorption and desorption zones via a fluidized bed or a sorbent wheel apparatus. In a sorbent wheel apparatus, solid sorbent is positioned in a structure (e.g., a wheel) and the rotation of the wheel carries the sorbent from a sorption zone to a desorption zone. For the sake of engineering simplicity, two or more fixed beds of solid sorbent are used with the hydrocarbon feed and desorption gas alternately being fed to the vessels. Preferably the desorption gas is passed countercurrent to the direction that the feed is passed through the bed. Generally, a simple two vessel sorber system will be used. However, if desired, a three or four bed cycle can be used. If the reforming is conducted in the absence of oxygen, and an oxygen-containing gas is used as the desorbing gas, it may be desired first to purge the bed of oxygen by passing hydrocarbon feed through the bed and direct that purge to the combustion before resuming the sorption mode. If a partial oxidation of the feed is used to generate heat for the reforming, the presence of oxygen in the feed is generally not adverse.

The solid sorbents used in the invention have the ability to sorb organosulfur compounds, and the preferred sorbents are those operable at lower temperatures. The preferred sorbents are characterized as being able to sorb dimethyl sulfide (e.g., from a methane stream containing 5 ppmv dimethyl sulfide at a temperature of 50° C. at an absolute pressure of 170 kPa). The sorbent is preferably also water tolerant, that is, it does not materially degrade when subjected to an inert stream (e.g., methane) containing 500 ppmv water at 30° C. for 1000 hours, and is carbon dioxide tolerant. The sorption may be in any convenient physical configuration including monolithic honeycombs and pellets or granular configurations. The active material for the sorption may be supported, or the structure may be substantially composed of the sorbent material.

Examples of sorbents include molecular sieves and molecular sieves that have been ion exchanged with one or more transition metals, such as Ag, Cu, Ni, Zn, Fe and Co. Molecular sieves include the X-type, A-type, Y-type, and beta-type. The type of sorbent will be selected considering the mechanism of the sorption/desorption cycle. For a water displacement cycle, the preferred adsorbent has a similar affinity for the sulfur compounds and water. The preferred adsorbents for the water displacement cycle are molecular sieve zeolites of the X-type, Y-type, or A-type. The preferred cations contained in the molecular sieve adsorbent include calcium, sodium, or transition metals such as copper and zinc. The most preferred molecular sieves are the X-type, especially 13X exchanged with zinc. Satokawa, et al., disclose in United States Patent Application publication 2001/14304 zeolite sorbents for removal of sulfur compounds at lower temperatures.

The type of sorbent used in the inert purge cycle is generally a hydrophobic molecular sieve, such as silicalite, ZSM-5 or a de-aluminated Y-type zeolite. The presence of 1 mol % to 15 mol % water in the desorption gas usually does not significantly affect the sulfur sorption, and the desorption gas functions as an inert sweep gas to desorb the weakly sorbed sulfur compounds.

The purge gas from the sorbent contains desorbed sulfur compounds. If desired, further sulfur removal may be effected prior to combusting the purge or releasing the combustion effluent to the atmosphere. This aspect of the invention is particularly attractive where the combustion is at least partially effected by catalytic combustion where the catalyst is adversely affected by sulfur or where substantially no emissions of sulfur compounds from the hydrogen generation process is sought. Preferably the further sulfur removal comprises hydrodesulfurization under hydrodesulfurization conditions including the presence of free hydrogen to produce a hydrogen sulfide-containing gas and sorption of hydrogen sulfide from the hydrogen sulfide-containing gas to provide an effluent containing reduced sulfur concentration. Where the desorption gas comprises at least a portion of the anode waste gas from the fuel cell, a convenient means for the further sulfur removal comprises hydrodesulfurization to convert sulfur compound to hydrogen sulfide and then sorption to remove hydrogen sulfide. As the anode waste gas contains free hydrogen, no additional source of hydrogen need be employed for the hydrodesulfurization. Moreover, adequate hydrogen remains in the stream after hydrodesulfurization for supporting combustion. Thus, this aspect of the invention is a continuous process for removing one or more organosulfur compounds from a hydrocarbon feed to a hydrogen generator that provides hydrogen to a fuel cell comprises:
a) contacting at least a portion of the feed with a bed of solid sorbent capable of reversibly sorbing at least one of said organosulfur compounds under sorption conditions for a time sufficient to sorb at least a portion of said at least one organosulfur compound to provide a sorption effluent, said bed being one of two or more beds adapted to cycle between sorption and desorption modes,
b) passing a regeneration gas comprising anode waste gas from a fuel cell to at least one other bed containing said solid sorbent under desorption conditions to regenerate the bed by removing sorbed organosulfur compound which organosulfur compound becomes contained in said regeneration gas to provide an organosulfur-containing purge,
c) subjecting the organosulfur-containing purge to hydrodesulfurization conditions to convert organosulfur compound to hydrogen sulfide and provide a hydrodesulfurization effluent, and
d) contacting the hydrodesulfurization effluent with a chemisorbent under sorption conditions for hydrogen sulfide, and
e) cycling the bed of step (a) to step (b) and the bed of step (b) to step (a).

Hydrodesulfurization conditions comprise temperatures typically in excess of about 100°, say, about 200° to 400°, C. and the presence of an effective amount of hydrodesulfurization catalyst. Any conventional hydrocarbon desulfurization catalyst may be used in the hydrodesulfurization zone, catalysts containing nickel and molybdenum are preferred. The pressure for the hydrodesulfurization may be any convenient pressure such as that of the purge gas from the desorption.

In order to reduce the overall size of the hydrogen generation equipment, the sorbent for the hydrogen sulfide is one capable of chemisorption. The reactive sorbents generally require temperatures, for instance, of at least about 50° C., and preferably at least about 100° C., and often between about 125° to 350° C. The chemisorbents include one or more of zinc oxide, iron oxide and copper oxide such as Synetix Puraspec 2030 or nickel on alumina, all of which have high capacities for hydrogen sulfide. Advantageously, the chemisorption is effected at substantially the same conditions as the hydrodesulfurization. The chemisorbent becomes spent and thus is typically replaced as required. One advantage of this preferred aspect of the invention is that little of hydrocarbons such as benzene will remain on the chemisorbent under the sorption conditions thus facilitating the disposal or regeneration of the spent chemisorbent. Reactive sorbents such as disclosed in WO 03/011436 may find application in the processes of this invention due to the relatively low temperatures at which sorption occurs.

A hydrogen generator and fuel cell system comprises:
a) a reformer in fluid communication with a supply of water for steam adapted to produce a reformate containing hydrogen, carbon dioxide and carbon monoxide effluent;
b) a carbon monoxide removal zone in fluid communication with the reformer to receive the reformate and produce a hydrogen product gas;
c) a fuel cell in fluid communication with the carbon monoxide removal zone to receive on an anode side the hydrogen product gas and in communication with a supply of oxygen-containing gas on a cathode side, said fuel cell having an anode waste gas port and a cathode waste gas port;
d) a combustor in fluid communication with a supply of oxygen-containing gas and with a supply of combustion fuel, said combustor adapted to combust the combustion fuel with the oxygen-containing gas to provide an effluent and to provide heat within the hydrogen generator and fuel cell system, and
e) at least two zones containing solid sorbent wherein one zone has an inlet in fluid communication with the supply of hydrocarbon feed and an outlet in fluid communication with the reformer to supply hydrocarbon for reforming such that the hydrocarbon feed passes through said one zone to contact solid sorbent, and wherein another zone has an inlet in fluid communication with a source of regeneration gas comprising at least one of oxygen-containing gas from the cathode waste gas port and combustion fuel from the anode waste gas port and an outlet in fluid communication with the combustor such that the gas passes through said another zone to contact solid sorbent, said zones being in a relationship to enable solid sorbent to cycle between contacting the hydrocarbon feed and the purge gas.

The invention will be further described in connection with the drawings.

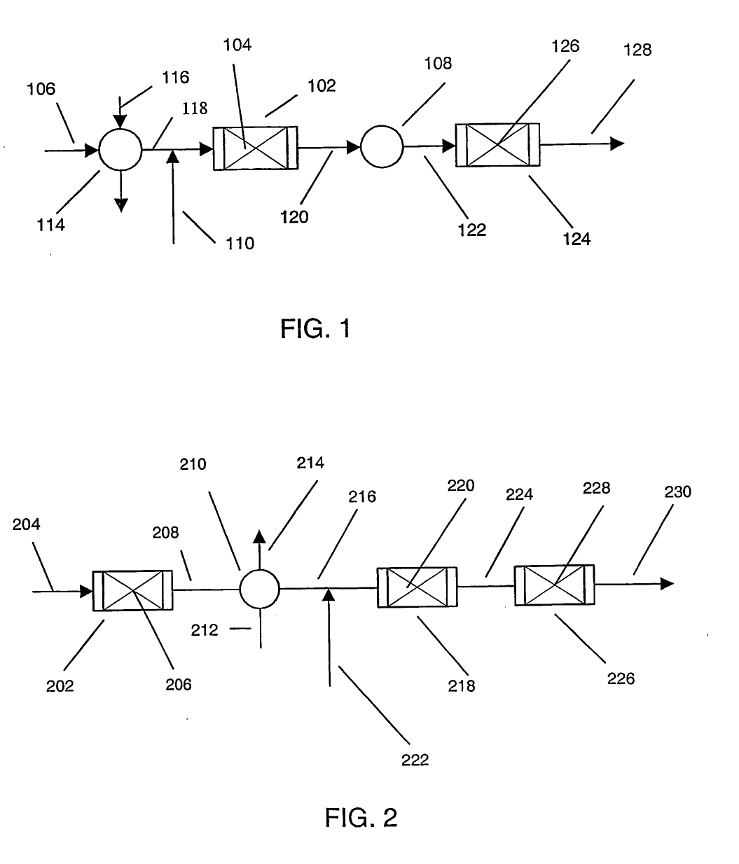

With reference to FIG. 1, an apparatus is depicted for removing sulfur compounds from a feed in which processes, the feed is first subjected to hydrolysis. Reactor 102 contains a bed of hydrolysis catalyst 104. Suitable hydrolysis catalysts are those capable of promoting the carbonyl sulfide hydrolysis reaction at temperatures of less than 100° C. The preferred catalysts promote the reaction at temperatures less than 70°, say, less than about 50°, e.g. 25° or 35° to 50° C. As a general rule, the lower the temperature, the slower is the rate of reaction. Hence a trade off exists between the gas space velocity and the temperature. If the temperature is too low, the bed may need to be of such a size that it is impractical. In preferred aspects of the invention, the gas hourly space velocity is at least about 500 hour⁻¹ and preferably greater than 1,000 hour⁻¹ for substantially complete conversion of carbonyl sulfide.

As can be readily appreciated, the temperature and space velocity can be adjusted to provide a desired conversion of carbonyl sulfide. At least about 70 percent of the carbonyl sulfide is converted to hydrogen sulfide, preferably at least about 95 percent, and sometimes the conversion is near 100 percent such that the treated feed contains less than about 50, more preferably less than about 10, parts per billion by volume (ppbv) carbonyl sulfide. The pressure of the hydrolysis can vary widely. However, since safety concerns dictate that the hydrogen generator operate at lower pressures, especially for residential applications, the pressure is often sufficient to provide a desulfurized feed to the hydrogen generator that requires no additional pressure adjustment. Hence, the absolute pressure is often between about 110 and 1000, say, 110 to 300 kPa.

The catalyst may be any suitable hydrolysis catalyst that promotes the reaction of carbonyl sulfide to hydrogen sulfide at a temperature of less than about 100° C., preferably less than about 50° C. By promoting the reaction it is meant that the catalyst is active such that perceptible conversion occurs at such temperatures. The most advantageous hydrolysis catalysts are those that can provide at least about 70 percent conversion of the carbonyl sulfide in a feed stream (1 ppmv in methane) at a temperature of 35° C. with a space velocity of 2,000 hour⁻¹.

Typical hydrolysis catalysts include alumina, zirconia and titania and mixtures thereof having a surface area of at least about 10, preferably at least about 50, e.g., 50 to 500, preferably at least about 100, say, about 100 to 400, square meters per gram (B.E.T.). The preferred catalysts are alumina catalysts comprising transition phase alumina, e.g., the chi, eta and rho phases, or gamma phase alumina. The alumina, zirconia and titania catalysts of high surface area tend to be acidic. With feeds containing olefins the acidity can promote a side polymerization reaction. To mitigate side reactions, dopants may be present that tend to neutralize the acidity such as sodium oxide and potassium oxide. Usually the dopants are present in amounts less than about 3 percent by weight of the catalyst. The catalyst may also contain promoters to increase the reaction rate. Iron, cobalt, nickel, copper and zinc have been proposed as promoters. See, for instance, J. West, et al., Catal. Letters, Vol. 74, p. 111, 2001.

The catalyst may be supported or the metal oxide may be formed into self-supporting shapes. The catalyst may be in any suitable configuration, e.g., pellets and monoliths.

By way of example, a granular alumina catalyst predominating in chi, eta and rho phases with a surface area of about 300 square meters per gram and about 1 weight percent soda (Na₂O) is contacted with a methane stream containing 3.6 ppmv hydrogen sulfide, 0.82 ppmv carbonyl sulfide, 3.7 ppmv dimethyl sulfide, 4.3 ppmv t-butyl mercaptan, 50 ppmv water and 1 mole percent carbon dioxide at an absolute pressure of 170 kPa. The conversion of carbonyl sulfide is set forth in the below table:

| Temperature, | Space | 1300 | 2300 |
|---|---|---|---|
| ° C. | Velocity, hr⁻¹ | % Conversion | % Conversion |
| 23 | | 82 | 68 |
| 35 | | 95 | 89 |
| 50 | | 99+ | 95 |

Returning to FIG. 1, an optional heat exchange system is shown. Advantageously, the hydrolysis is conducted at temperatures near ambient and no heat exchange equipment will be necessary. Moreover, if the desulfurization apparatus is placed proximate to the hydrogen generator, where higher temperatures exist to effect, e.g, the reforming and water gas shift reactions, the environmental heat may be sufficient by itself to maintain suitable activity of the hydrolysis catalyst. However, for less active catalysts or where cooler ambient conditions exist, it may be desired to increase the temperature of the hydrocarbon-containing feed. As shown, feed from line 106 is passed to heat exchanger 114. The temperature of the feed is increased in heat exchanger 114 by indirect heat exchange with another fluid, e.g., a warm process or waste stream in the hydrogen generator or a waste stream from a fuel cell. The heat-exchange fluid is provided via line 116. The heated feed is passed via line 118 to reactor 102. An optional water source is provided by line 110 should water need to be added to the feed to provide a desirable water content for the hydrolysis. This water source may be a pure water stream or an air stream, thereby providing moisture from atmospheric humidity. The location of the addition of the water is not critical and may be before or after the heat exchanger 114.

The effluent from reactor 102 is passed via line 120 to heat exchanger 108, which cools the process stream, and then from the heat exchanger to sorber 124. Alternatively, heat exchanger 108 can be simply a length of piping, where ambient heat loss provides adequate cooling. Sorber 124 contains solid sorbent 126. The effluent from sorber 124 is passed via line 128 to the hydrogen generator.

In the preferred aspects of the invention, the sorption is conducted at a low temperature, for instance, from about 0° to 50° C., most preferably from about 10° to 35° C. The pressure is usually based upon the pressure of the feed from reactor 102. The volume of the sorbent bed 126 is a design choice based upon the duration that the bed is to be used before being replaced or regenerated with a given concentration of sulfur compounds in the feed. Usually, the gas hourly space velocity is between about 10 and 1,000 or 2,000 hour⁻¹. The sorbent may be in any convenient shape such as pellets or monoliths.

When spent, the sorbent can be replaced or regenerated using pressure and/or temperature swing techniques. The sweep gas may be any suitable stream such as the incoming air for the hydrogen generator or a waste stream from the hydrogen generator or fuel cell.

By way of example a methane stream containing 3.1 ppmv hydrogen sulfide, 0.76 ppmv carbonyl sulfide, 3.2 ppmv dimethyl sulfide, 3.6 ppmv t-butyl mercaptan, 50 ppmv water and 1 mole percent carbon dioxide at a pressure of 170 kPa and temperature of 20° C. is contacted with a 13X molecular sieve that has been ion exchanged with zinc. About 1.0 normal cubic meter of the stream per cubic centimeter of molecular sieve is passed through the bed and the effluent gases analyzed to determine sulfur content. Virtually all the organosulfur compounds and hydrogen sulfide are sorbed on the molecular sieve. Substantially none of the carbonyl sulfide is sorbed.

FIG. 2 relates to the aspect of this invention where the organosulfur compound are sorbed prior to the hydrolysis. This aspect of the invention is of particular interest where the feed is for a hydrogen generator that needs to produce sufficient hydrogen for commercial purposes, e.g., for fuel for vehicles or fuel cells to generate electricity for businesses, or for chemical plants.

Feed is provided by line 204 to sorber 202 containing sorbent bed 206. The operation and sorbents are as set forth above except that water will be sorbed. The effluent from sorber 202 exiting via line 208 will therefore be depleted in water but will contain carbonyl sulfide which is substantially not sorbed. As shown, the effluent from sorber 202 is directed by line 208 to heat exchanger 210 to increase the temperature for the hydrolysis reaction. Heat exchanger 210 can use a warmer fluid provided by line 212 and exhausted by line 214. The heat exchange fluid can be a fluid of the type described for heat exchanger 114 above. The temperature of the feed is increased to that described for heat exchanger 114. Heat exchanger 210 is optional and need only be used where the temperature desired for the hydrolysis reaction is higher than that of the effluent from sorber 202. The heated feed passes via line 216 to reactor 218 containing catalyst bed 220.

Since the sorber will remove water from the feed, water must be added to the feed passing to reactor 218. This water is supplied by line 222. Advantageously the amount of water can be controlled to provide that desired for the hydrolysis reaction. The catalyst, operating conditions including the concentration of water in the feed passing to the reactor is the same as that described for reactor 102 in connection with FIG. 1 except that the feed will be substantially devoid of organosulfur compounds and hydrogen sulfide.

As the hydrolysis reaction results in the conversion of carbonyl sulfide to hydrogen sulfide, an additional sulfur removal step needs to be employed. Accordingly, the effluent from reactor 218 is passed via line 224 to sorber 226. Heat exchange of the feed passing to sorber 226 may or may not be necessary depending upon the type of sorption conducted and the temperature of the feed in line 224.

As the sulfur compound remaining to be removed is hydrogen sulfide, and hydrogen sulfide is essentially only in an amount commensurate with the carbonyl sulfide converted in the reactor, the breadth of sorbent options is wide without adversely affecting the economics of the desulfurization apparatus. Thus the sorbents may range from physical sorbents such as molecular sieves to reactive sorbents such as zinc oxide and iron oxide.

The reactive sorbents generally require higher temperatures for efficient operation, for instance, at least about 100° C., and often between about 125° to 350° C. These sorbents include one or more of zinc oxide, iron oxide and copper oxide such as Synetix Puraspec 2030 or nickel on alumina, all of which have high capacities for hydrogen sulfide. To reach these higher temperatures, heat exchange with fluids from the hydrogen generator or fuel cell may be convenient. As this is the last stage of the desulfurization process and the feed needs to be heated to reforming temperatures, integration with a hydrogen generator will assure efficient energy use. Zinc or iron hydroxycarbonates may also be useful and may be capable of operation without additional heating of the feed stream.

The desulfurized feed is discharged through line 230 for use in the hydrogen generator.

In accordance with this invention, the hydrolysis and hydrogen sulfide removal may be positioned within the same vessel.

Advantageously, the desulfurized feed contains less than about 100, often less than about 50, preferably less than about 10, ppbv (parts per billion by volume) of sulfur compounds.

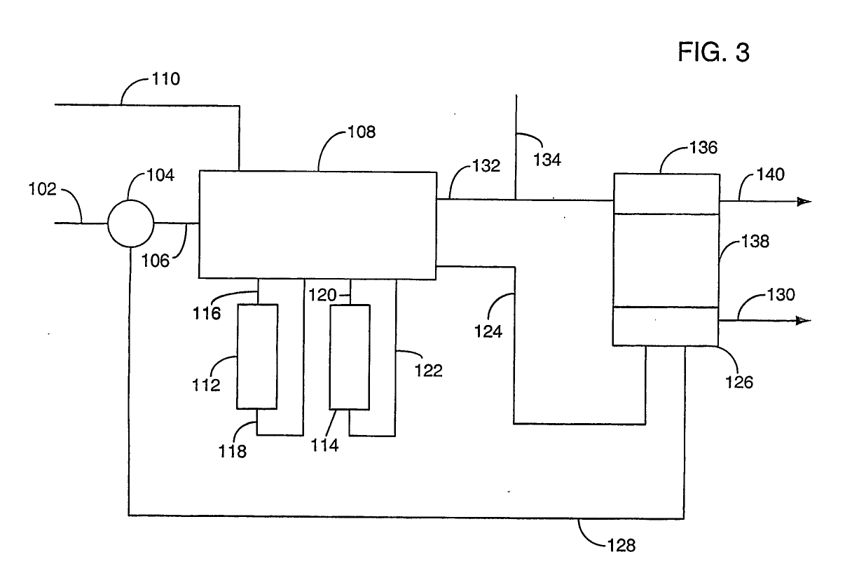

With reference to FIG. 3, an apparatus is depicted for removing organosulfur compounds from a hydrocarbon feed to a hydrogen generator. Hydrocarbon feed is passed via line 102 to distributor 104 where it is split and metered in two streams. One stream is used for combustion to heat the reformer and the other is the feed for reforming. This latter stream is passed via line 106 to valve mechanism 108.

Valve mechanism 108 also receives oxygen-containing gas, e.g., air, from line 110. Valve mechanism 108 is in fluid communication with two vessels, 112 and 114, each containing a bed of pelleted solid sorbent.

In operation, the feed from line 106 is directed by the valve mechanism alternatingly to each of the two vessels while air from line 110 is directed to the other of the vessels. In more detail, the feed is directed via line 116 to vessel 112 where it passes through a bed of solid sorbent to remove organosulfur compounds. The effluent from vessel 112 is passed via line 118 to valve mechanism 108 which then directs it to a heat exchanger section of the reformer. Simultaneously, the valve mechanism is directing air from line 110 via line 122 to vessel 114 for desorption of organosulfur compound. As shown, the air is passed countercurrent to the direction that the hydrocarbon feed is passed through the vessel. The air containing desorbed organosulfur compound is passed via line 120 to valve mechanism 108 where it is then directed to a combustor associated with the reformer.

After a period of time, the valve mechanism switches the operations of the vessels. Vessel 112 goes from sorption to desorption mode by valve mechanism 108 stopping flow of the feed to the vessel while commencing to direct air from line 110 through line 118 to vessel 112. The desorption stream from vessel 112 goes to the valve mechanism and is directed for use in the combustion. At the same time, vessel 114 is switched from desorption to sorption mode by the valve mechanism. The hydrocarbon feed is passed via line 120 to vessel 114 and the effluent from vessel 114 is returned via line 122 to valve mechanism 108 for direction to the reformer.

The valve mechanism directs the air now containing desorbed organosulfur compounds via line 124 to combustor 126. A portion of the hydrocarbon feed is directed by distributor 104 via line 128 as the fuel for the combustion. The exhaust from combustor 126 exits via line 130. This exhaust can be subjected to further heat recovery. For purposes of this schematic representation a single combustor is depicted. It should be understood that the combustor may be multifunctional and may have multiple burners. For instance, some of the heat generated by the combustion may be used to preheat the gases passing to the reformer, and some of the heat is used to provide heat to the reformer during the endothermic reforming process. It should be understood that heat from the combustion can be provided for the reforming in various ways. For example, the heat from the combustion may be applied through indirect heat exchange to the reforming zone. Alternatively or additionally, it may be heat exchanged with streams passing to the reforming zone, e.g., by preheating one or more of feed, water and oxygen-containing gas, if a partial oxidation is used, that are passed to the reforming zone.

A particular advantage of this aspect of the invention is that not only are the organosulfur compounds oxidized in the combustor to sulfur dioxide but also hydrocarbons sorbed on the sorbent or present in the interstices, are purged during the desorption mode and are combusted to carbon dioxide and water.

Valve mechanism 108 directs the hydrocarbon feed with sulfur compound removed from the sorbent to the reformer. As shown, the gas is passed via line 132 where it is combined with water for the reforming supplied by line 134 to preheater 136. Preheater 136 uses the reformate from reformer 138 for indirect heat exchange with the hydrocarbon feed. The preheated feed is directed by preheater 136 to the reformer and the hydrogen-containing reformate is passed through preheater 136 and exits via line 140 where it may be subjected to further operations such a water gas shift and selective oxidation to reduce carbon monoxide content.

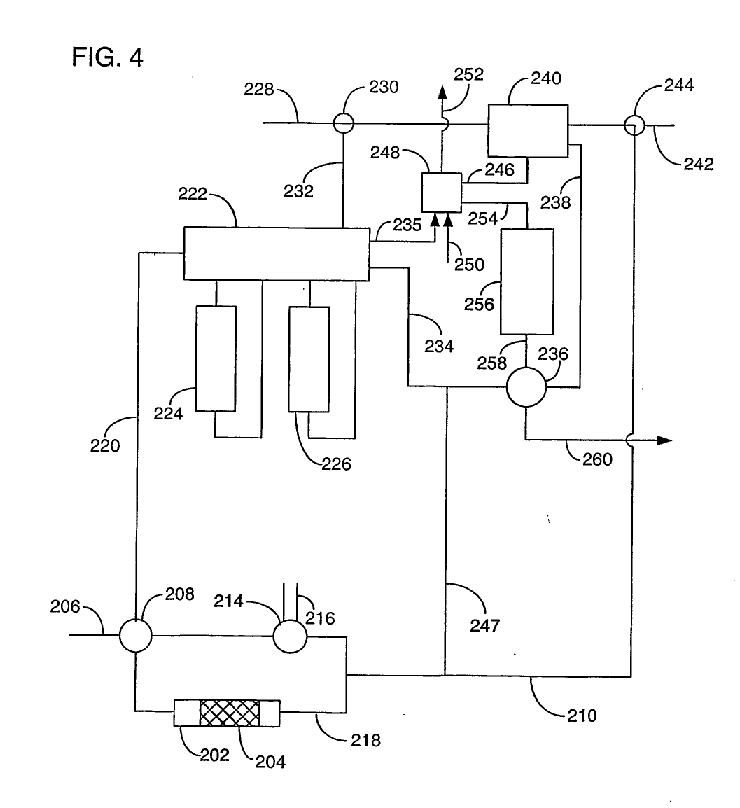

FIG. 4 relates to the aspect of this invention where a regenerable sorbent is used in combination with a carbonyl sulfide hydrolysis stage to remove sulfur from a feed gas.

Reactor 202 contains a bed of hydrolysis catalyst 204. Suitable hydrolysis catalysts are those capable of promoting the hydrolysis reaction at temperatures of less than 100° C. The preferred catalysts promote the reaction at temperatures less than 70°, say, less than about 50°, e.g. 25° or 35° to 50° C. As a general rule, the lower the temperature, the slower is the rate of reaction. Hence a trade off exists between the gas space velocity and the temperature. If the temperature is too low, the bed may need to be of such a size that it is impractical. In preferred aspects of the invention, the gas hourly space velocity is at least about 500 hour⁻¹ and preferably greater than 1,000 hour⁻¹ for substantially complete conversion of carbonyl sulfide.

As can be readily appreciated, the temperature and space velocity can be adjusted to provide a desired conversion of carbonyl sulfide. At least about 70 percent of the carbonyl sulfide is converted to hydrogen sulfide, preferably at least about 95 percent, and sometimes the conversion is near 100 percent such that the treated feed contains less than about 50, more preferably less than about 10, ppbv (parts per billion by volume) carbonyl sulfide. The pressure of the hydrolysis can vary widely. However, since safety concerns dictate that the hydrogen generator operate at lower pressures, especially for residential applications, the pressure is often sufficient to provide a desulfurized feed to the hydrogen generator that requires no additional pressure adjustment. Hence, the absolute pressure is often between about 110 and 1000, say, 110 to 300 kPa.

The catalyst may be any suitable hydrolysis catalyst that promotes the reaction of carbonyl sulfide to hydrogen sulfide at a temperature of less than about 100° C., preferably less than about 50° C. By promoting the reaction it is meant that the catalyst is active such that perceptible conversion occurs at such temperatures. The most advantageous hydrolysis catalysts are those that can provide at least about 70 percent conversion of the carbonyl sulfide in a feed stream (1 ppmv in methane) at a temperature of 35° C. with a space velocity of 2,000 hour⁻¹.

Returning to FIG. 4, an optional heat exchange system is shown. Advantageously, the hydrolysis is conducted at temperatures near ambient and no heat exchange equipment will be necessary. Moreover, if the desulfurization apparatus is placed proximate to the hydrogen generator, where higher temperatures exist to effect, e.g, the reforming and water gas shift reactions, the environmental heat may be sufficient by itself to maintain suitable activity of the hydrolysis catalyst. However, for less active catalysts or where cooler ambient conditions exist, it may be desired to increase the temperature of the hydrocarbon feed.

As shown, feed from line 206 is passed to heat exchanger 214. The temperature of the feed is increased in heat exchanger 214 by indirect heat exchange with another fluid, e.g., a warm process or waste stream in the hydrogen generator or a waste stream from a fuel cell. The heat-exchange fluid is provided via line 216. The heated feed is passed via line 218 to reactor 202. An optional water source is provided by line 210 should water need to be added to the feed to provide a desirable water content for the hydrolysis. This water source may be a pure water stream or an air stream, thereby providing moisture from atmospheric humidity. The location of the addition of the water is not critical and may be before or after the heat exchanger 214.

The effluent from reactor 202 is passed via line 220 to heat exchanger 208, which cools the process stream, and then from the heat exchanger to valve mechanism 222 which is in fluid communication with vessels 224 and 226 containing solid sorbent. Alternatively, heat exchanger 208 can be simply a length of piping, where ambient heat loss provides adequate cooling.

Oxygen-containing gas, e.g., air, in line 228 is passed to distributor 230 which directs part of the stream via line 232 to valve mechanism 222 for use as the desorption gas. The valving mechanism operation and the flows to and from vessels 224 and 226 are similar to that described in connection with FIG. 3 and is not repeated here. Two effluent streams leave valve mechanism 222, a hydrocarbon feed stream having reduced sulfur via line 234 and an oxygen-containing gas stream containing desorbed sulfur via line 235.

The desulfurized hydrocarbon feed in line 234 is admixed with water from line 247 and is passed to heat exchanger 236 for heat exchange with hot reformate. The heated feed is then passed via line 238 to mixer 240. Mixer 240 receives water via line 242 through distributor 244 for use in the reforming and air from line 228 through distributor 230. Distributor 244 also directs water to line 210 for use in the hydrolysis.

The effluent from mixer 240 passes via line 246 to preheater 248. Preheater 248 comprises a combustor and indirect heat exchanger for transfer of the heat of combustion to the mixture of feed, air and water (steam) to be reformed. To the combustor section is provided the oxygen-containing gas used to desorb the sorbent via line 235 and a fuel via line 250. The fuel may be a portion of the hydrocarbon feed from line 206. The combustion exhaust is discharged via line 252.

The heated mixture leaves preheater 248 via line 254 and enters autothermal reformer 256 to produce a hydrogen-containing gas. The reformate exits reformer 256 via line 258 whereupon it enters heat exchanger 236 and then exits via line 260. The reformate in line 260 may be subjected to further unit operations to reduce carbon monoxide content, such as water gas shift and selective oxidation, and to purification such as by membranes, pressure swing absorption, or chemical processes to remove carbon dioxide such as the Benfield process.

While FIG. 4 shows the sorption being after the hydrolysis, it should be understood that the hydrolysis and a sorption step to remove hydrogen sulfide can follow the organosulfur compound sorption. As the sulfur compound remaining to be removed is hydrogen sulfide, and hydrogen sulfide is essentially only in an amount commensurate with the carbonyl sulfide converted in the reactor, the breadth of sorbent options is wide without adversely affecting the economics of the desulfurization apparatus. Thus the sorbents may range from physical sorbents such as molecular sieves to reactive sorbents such as zinc oxide and iron oxide.

The reactive sorbents generally require higher temperatures for operation, for instance, at least about 100° C., and often between about 125° to 350° C. These sorbents include one or more of zinc oxide, iron oxide and copper oxide such as Synetix Puraspec 2030 or nickel on alumina, all of which have high capacities for hydrogen sulfide. To reach these higher temperatures, heat exchange with fluids from the hydrogen generator or fuel cell may be convenient.

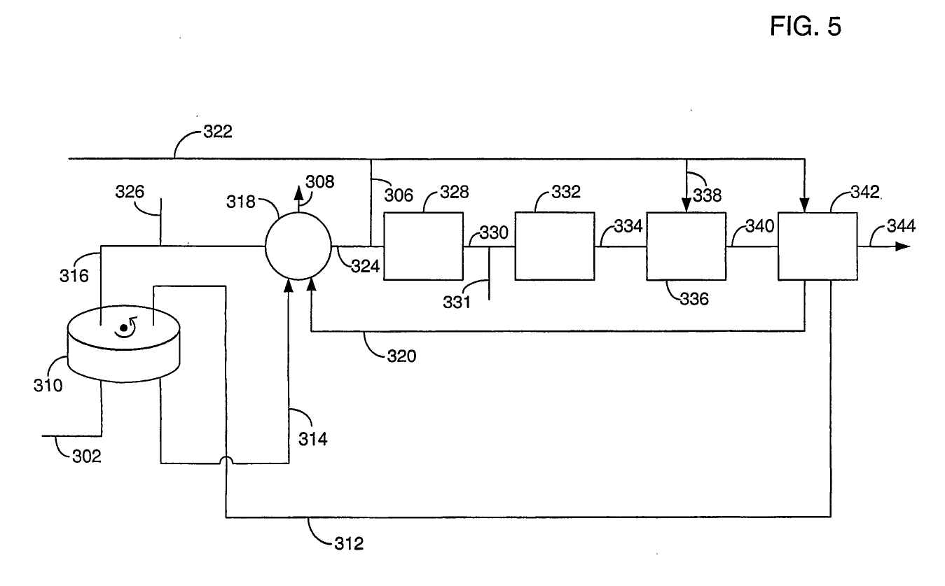

With reference to FIG. 5, an integrated hydrogen generator and fuel cell is depicted using a moving bed of sorbent to remove organosulfur compounds. A hydrocarbon feed from line 302 is passed into a rotary wheel adsorber 310 containing a monolith solid sorbent. Waste anode gas via line 312 is passed in a countercurrent direction through the regeneration section of the wheel to effect desorption. The desorption gases are passed via line 314 to combustor/heat exchanger 318 where they are combusted with cathode waste gas from line 320. The combustion effluent is discharged via line 308.

The combustor/heat exchanger receives a mixture of the hydrocarbon feed that has organosulfur compound removed via line 316 from adsorber 310 and water from line 326. Through indirect heat exchange with the combustion gases, this mixture is heated and passed via line 324 to reformer 328. Air is added to this heated mixture via line 306 prior to entering the reformer.

In reformer 328, hydrogen is generated from the feed and the hydrogen-containing reformer effluent is passed via line 330 to water gas shift reactor 332 and from there via line 334 to selective oxidation unit 336. Water for cooling the reformer effluent and for the water gas shift reaction is provided via line 331, and air for the selective oxidation is provided via line 338. In the water gas shift reactor, water and carbon monoxide are reacted over catalyst under water gas shift conditions to produce carbon dioxide and hydrogen. In the selective oxidation unit, carbon monoxide is oxidized under selective oxidation conditions to carbon dioxide.

The effluent from the selective oxidation unit is passed via line 340 to fuel cell 342 as the hydrogen feed. Air from line 322 is used as the cathode feed to the fuel cell. Electricity is generated and is distributed via line 344. The cathode waste gas is exhausted in line 320 and the anode waste gas is exhausted in line 312.

Advantageously, the desulfurized feed contains less than about 100, often less than about 50, preferably less than about 10, ppbv (parts per billion by volume) of sulfur compounds.

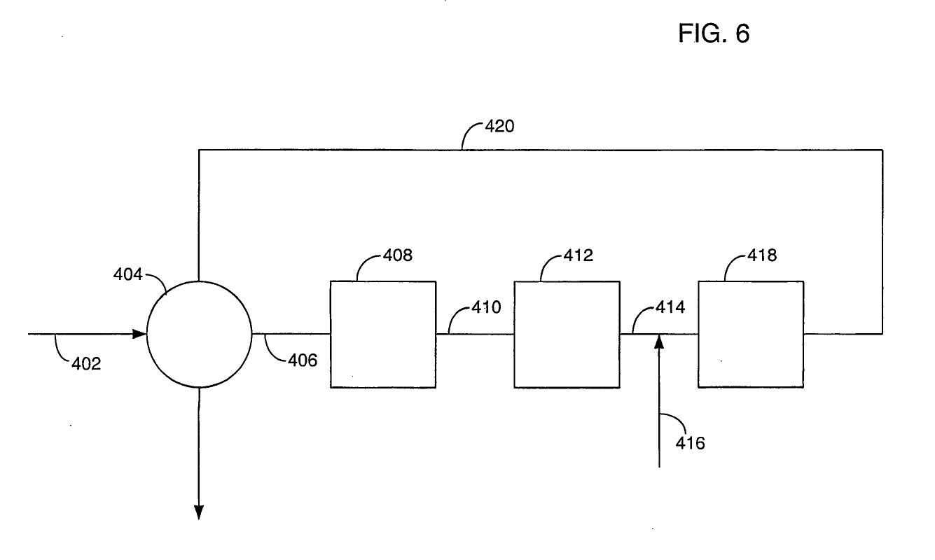

In FIG. 6, desorption gases from the regeneration of a bed of sorbent are passed via line 402 to heat exchanger 404 to provide a stream containing anode waste gas and desorbed sulfur compounds at a temperature suitable for hydrodesulfurization. The heated gases are passed via line 406 to hydrodesulfurization vessel 408 containing a hydrodesulfurization catalyst such as sulfided nickel molybdate where the sulfur compounds are reacted with hydrogen contained in the anode waste gas to produce hydrogen sulfide. The effluent from the hydrodesulfurization is passed by line 410 to sorption vessel 412 which contains sorbent for hydrogen sulfide such as zinc oxide. The gas having the hydrogen sulfide removed is passed to catalytic combustor 418 via line 414. As shown, air for the catalytic combustion is provided to line 414 through line 416. The catalytic combustion generates a combustion effluent and heat. As discussed above, heat from the combustion may be used for providing heat for the reforming reactions. Nevertheless, the combustion effluent will still be at an elevated temperature and thus, the effluent from combustor 418 is passed via line 420 to heat exchanger 404 where it is used for heating the desorption gases.

What is claimed is:

1. In a continuous process for generating hydrogen from a hydrocarbon feed that contains one or more organosulfur compounds by reforming the hydrocarbon feed to provide a reformate containing hydrogen, carbon dioxide and carbon monoxide and reducing the concentration of carbon monoxide in the reformate, the improvement comprising:
a) contacting at least a portion of the feed with a bed of solid sorbent capable of reversibly sorbing at least one of said organosulfur compounds under sorption conditions for a time sufficient to sorb at least a portion of said at least one organosulfur compound to provide a sorption effluent, said bed being one of two or more beds adapted to cycle between sorption and desorption modes,
b) reforming the sorption effluent in the presence of steam under reforming conditions to provide a hydrogen-containing stream,
c) passing a regeneration gas comprising at least one of a combustion fuel, provided that the fuel has an essential absence of sulfur compound, and oxygen-containing gas to at least one other bed containing said solid sorbent under desorption conditions to regenerate the bed by removing sorbed organosulfur compound which organosulfur compound becomes contained in said regeneration gas to provide an organosulfur-containing purge, and using the organosulfur-containing purge in a combustion to provide heat for use within the process and to convert organosulfur compound to sulfur dioxide, and
d) cycling the bed of step (a) to step (c) and the bed of step (c) to step (a).

2. The process of claim 1 wherein the regeneration gas comprises oxygen-containing gas.

3. The process of claim 1 wherein the hydrogen-containing stream of step (b) is fed to a fuel cell, an anode waste gas is withdrawn from the fuel cell, and the regeneration gas comprises at least a portion of the anode waste gas.

4. The process of claim 1 wherein the regeneration gas further comprises water vapor.

5. The process of claim 4 wherein the sorption and desorption is by water displacement.

6. The process of claim 4 wherein the sorbent comprises hydrophobic molecular sieve.

7. The process of claim 1 wherein the sorbent comprises molecular sieve ion exchanged with one or more transition metals.

8. The process of claim 1 wherein the organosulfur-containing purge is subjected to further sulfur removal prior to combustion.

9. The process of claim 1 wherein the further sulfur removal comprises hydrodesulfurization to convert organosulfur compounds to hydrogen sulfide and reactive sorption to sorb hydrogen sulfide.

10. A hydrogen generator for producing hydrogen from a hydrocarbon feed which also contains at least one organosulfur compound comprising:
a) a reformer in fluid communication with a supply of water for steam;
b) a combustor in fluid communication with a supply of oxygen-containing gas and with a supply of combustion fuel, said combustor adapted to combust the combustion fuel with the oxygen-containing gas to provide an effluent and provide heat within the hydrogen generator, and
c) at least two zones containing solid sorbent wherein one zone has an inlet in fluid communication with a supply of hydrocarbon feed and an outlet in fluid communication with the reformer to provide hydrocarbon feed for reforming such that the hydrocarbon feed passes through said one zone to contact solid sorbent, and wherein another zone has an inlet in fluid communication with a supply of regeneration gas comprising at least one of oxygen-containing gas and combustion fuel and an outlet in fluid communication with the combustor such that the supply of regeneration gas passes through said another zone to contact solid sorbent, said outlet being in fluid communication with the combustor to provide at least one of oxygen-containing gas and combustion fuel, said zones being in a relationship to enable solid sorbent to cycle between contacting the hydrocarbon feed and the purge gas.

11. A hydrogen generator and fuel cell system comprising the hydrogen apparatus of claim 10 and further comprising
a) a carbon monoxide removal zone in fluid communication with the reformer to receive the hydrogen and carbon monoxide effluent and produce a hydrogen product gas; and
b) a fuel cell in fluid communication with the carbon monoxide removal zone to receive on an anode side the hydrogen product gas and in communication with a supply of oxygen-containing gas on a cathode side, said fuel cell having an anode waste gas port and a cathode waste gas port,
c) in which at least one of the anode waste gas port and the cathode waste gas port is a supply of regeneration gas.

12. The hydrogen generator and fuel cell of claim 11 in which the anode waste gas port is the supply of regeneration gas.

13. An apparatus for removing sulfur compounds including CXS, wherein X may be oxygen or sulfur, from a hydrocarbon-containing gas stream comprising:
a) a first reactor having a gas stream inlet and a spaced apart gas stream outlet, said first reactor containing a bed of catalyst positioned such that a gas stream passing from said inlet to said outlet passes through said bed, said catalyst comprising a hydrolysis catalyst capable of promoting the reaction of CXS with water vapor at a temperature of less than about 100° C., and
b) a second vessel having a gas stream inlet in fluid communication with the gas stream outlet of the first reactor and a gas stream outlet, said second vessel containing a bed of solid sorbent positioned such that a gas stream passing from said inlet to said outlet passes through said bed, said solid sorbent being capable of sorbing dimethyl sulfide at a temperature of 50° C. from a methane stream containing 50 ppmv water.

14. An apparatus for removing sulfur compounds including CXS, wherein X may be oxygen or sulfur, from a hydrocarbon-containing gas stream comprising:
a) a first vessel having a gas stream inlet and a gas stream outlet, said first vessel containing a bed of solid sorbent positioned such that a gas stream passing from said inlet to said outlet passes through said bed, said solid sorbent being capable of sorbing dimethyl sulfide at a temperature of 50° C. from a methane stream containing 50 ppmv water,
b) a means to introduce water vapor into a gas stream, said means being in fluid communication with the gas stream outlet of the first vessel,
c) a second vessel having a gas stream inlet in fluid comunication with the means for introducing water into a gas stream and a spaced apart gas stream outlet, said second vessel containing a bed of catalyst positioned such that a gas stream passing from said inlet to said outlet passes through said bed, said catalyst comprising a hydrolysis catalyst capable of promoting the reaction of CXS with water vapor at a temperature of less than about 100° C., and
d) a third vessel having a gas stream inlet in fluid communication with the outlet of the second vessel and a spaced apart gas stream outlet, said third vessel containing a solid bed of sorbent for hydrogen sulfide positioned such that a gas stream passing from said inlet to said outlet passes through said bed.

15. A process for removal of sulfur compounds, including organosulfur compounds and CXS, wherein X may be oxygen or sulfur, from a hydrocarbon stream containing the same comprising:
a) providing a hydrocarbon-containing gas containing from about 5 to 100 moles of water per mole of CXS,
b) contacting said stream under hydrolysis conditions including a temperature of about 25° to 100° C. with hydrolysis catalyst for a time sufficient to hydrolyze at least about 70 percent of the CXS to hydrogen sulfide and carbon dioxide and produce a hydrocarbon-containing stream having reduced CXS content, and
c) contacting the stream having reduced CXS content with a solid sorbent tolerant of water and capable of sorbing organosulfur compound and hydrogen sulfide, said contacting being under sorption conditions including a temperature of less than about 50° C. for a time sufficient to sorb at least about 70 mole percent of the total sulfur compounds contained in the stream having a reduced CXS content.

16. The process of claim 15 wherein the hydrolysis catalyst comprises at least one of alumina, titania, and zirconia having a surface area of at least about 100 square meters per gram (B.E.T.).

17. The process of claim 15 wherein the sorbent comprises molecular sieve ion exchanged with one or more transition metals.

18. A process for removal of sulfur compounds, including organosulfur compound, and CXS, from a hydrocarbon stream containing the same comprising:
a) contacting the stream under sorption conditions including a temperature of less than about 50° C. with a solid sorbent tolerant of water and capable of sorbing organosulfur compound for a time sufficient to remove at least about 70 mole percent of the organosulfur compounds but less than about 50 percent of the CXS, to provide a CXS-containing effluent,
b) adding water to the CXS-containing stream to provide about 5 to 100 moles of water per mole of CXS,
c) contacting the water containing stream under hydrolysis conditions including a temperature of about 25° to 200° C. with hydrolysis catalyst for a time sufficient to hydrolyze at least about 70 percent of the CXS to hydrogen sulfide and carbon dioxide to produce a hydrogen sulfide-containing stream having reduced CXS content, and
d) contacting the stream having reduced CXS content with a solid sorbent capable of sorbing hydrogen sulfide, said contacting being under sorption conditions for a time sufficient to sorb at least about 70 percent of the hydrogen sulfide.

19. The process of claim 18 wherein the sorbent for removal of organosulfur compounds comprises molecular sieve ion exchanged with one or more transition metals.

20. The process of claim 18 wherein the hydrogen sulfide sorbent comprises at least one of zinc hydroxycarbonate, zinc oxide, iron oxide, iron hydroxycarbonate and copper oxide or nickel on alumina.
